(19) United States
(12) Patent Application Publication
(10) Pub. No.: US 2026/0001161 A1
(43) Pub. Date: Jan. 1, 2026

(54) METHOD AND APPARATUS FOR LASER PROCESSING

(71) Applicant: SHANGHAI NAGOYA PRECISION TOOLS CO., LTD., Shanghai (CN)

(72) Inventor: SI-RUI SUN, Shanghai (CN)

(21) Appl. No.: 18/880,969

(22) PCT Filed: Oct. 27, 2023
(86) PCT No.: PCT/CN2023/127406

§ 371 Date: Jan. 3, 2025

(30) Foreign Application Priority Data
Nov. 10, 2022 (CN) 202211409771.7

(51) Int. Cl. B23K 26/06; B23K 26/0622; B23K 26/38

(52) U.S. Cl. CPC B23K 26/0652; B23K 26/0624; B23K 26/38

(57) ABSTRACT

A method for cutting a material using a laser beam, comprising: providing a first wedge prism (310) and a second wedge prism (320) on a propagation path of a laser beam (10), and enabling the laser beam to enter the first wedge prism at an incident angle greater than 0 degree and less than 90 degrees and then to enter the second wedge prism at an incident angle greater than 0 degree and less than 90 degrees; focusing, by using a focusing wedge prism (400), the laser beam emitted from the second wedge prism and then applying the focused laser beam on a material (20); and deviating the position of the second wedge prism relative to the first wedge prism, and then forming a laser processing pattern on the material.

### TECHNICAL FIELD

The invention relates to a material forming method, especially relates to a laser as means to process and form the material (i.e.: hole or groove), and a device for carrying out the method.

### BACKGROUND TECHNOLOGY

Hole processing, milling processing and reaming processing are common material processing means in the industry, so as to process the material into the product with the desired characteristics, such as: The invention Claims a plate with hole characteristics and a cavity with an arc surface. The most common means for completing these processes are cutters, such as: drill, milling cutter and reamer and so on. The purpose of removing material by means of laser (field) has been widely applied.

For example: The processing of materials by means of laser light is common in the field of metal processing, such as: Laser technology such as laser cutting, laser welding, laser quenching, laser derusting and so on has been widely used in industrial production, which uses focused high-energy laser beam to irradiate materials, and through the photo-thermal electric effect in the space range where the energy density of the beam is higher than the damage threshold value of the material (such as: Gasification evaporation, electron avalanche and so on) to ablate and remove the material. The ablation of materials of particular shapes, shapes and specifications is then accomplished (also commonly referred to as “cutting”) by the movement of the light beam relative to the material. It reaches the purpose of making the needed product.

A Galvo scanning system, also known as an ammeter scanner, is composed of an X-Y optical scanning head, an electronically driven amplifier, and an optical reflecting lens. The signal provided by the computer controller drives the optical scanning head by the drive amplifying circuit so as to control the deflection of the laser beam on the X-Y plane. The design idea of the galvanometer completely follows the design method of the ammeter, the lens replaces the watch hand, and the signal of the probe is replaced by the direct current signal of −5V-5V or −10V-10V controlled by the computer, so as to finish the predetermined action. The working principle is as follows: the laser beam is incident on two reflecting mirrors (scanning mirror); the reflecting angle of the reflecting wedge prism is controlled by the computer; the two reflecting wedge prisms can be respectively along X, the laser focusing point with power density moves on the marking material according to the needed requirement so as to ablate on the surface of the material.

The laser processing technology implemented by the galvanometer has been widely used in the industrial field, such as: laser marking, flying welding, laser quenching, adding material manufacturing and precise cutting and so on. According to different application fields, the shape drawn by the vibration wedge prism is mainly divided into a vector graph and a dot matrix graph. Based on the principle of movement of the galvanometer (so as to control the angle of the reflector in the X and Y directions to realize the point-by-point scanning movement of the focusing light spot along the X axis and the Y axis), when the movement track is a curve (such as: the circular arc or sine curve) track will be firstly decomposed into multiple sections of straight lines with short length, and the polygon formed by it, the focusing light spot is driven by the vibration wedge prism to move along multiple short and small straight lines or polygon formed by the short and small straight lines by means of circular arc interpolation or direct end-to-end connection so as to finish the drawing of the curve pattern.

This technique has the following disadvantages when processing small circular arc shape (R is less than or equal to 0.05 mm): on one hand, the side length corresponding to the polygon is too short to draw the round shape; on the other hand, because the side length of the polygon is too short, the requirement for the acceleration and deceleration speed of the motor is high, the frequent acceleration and deceleration speed not only shortens the service life of the vibration wedge prism main body, but also causes the temperature rise of the vibration wedge prism motor to be increased, the temperature rise of the amplified zero point is shifted, and the image distortion is easily caused; Third, when the “pattern” needs to be filled, the “polygon” is filled with space and is difficult to fill. In this way, the general practice of the industry is to adopt hardware upgrading means, such as: improving the resolution of the vibration wedge prism angle sensor, or using the digital signal driving control mode with high bandwidth to replace the analogue signal driving control mode with relatively low bandwidth, or using the low inertia lens, or increasing the active cooling (water, air cooling) and so on to pertinently solve the temperature rise and drift, the acceleration and deceleration inertia is large and the side length of the polygon is too short. There is no solution for improving the motion mode of the vibration wedge prism main body.

### SUMMARY

An objective of the present invention is to provide a method for laser processing of a material in a pattern.

Another objective of the present invention is to provide a method for laser processing, which reduces the high requirement for motor acceleration and deceleration, and facilitates the continuous laser processing.

A further objective of the present invention is to provide a method for laser processing to improve the accuracy of laser processing of a material in a pattern.

A yet objective of the present invention is to provide a device for laser processing to facilitate laser processing of materials in a pattern.

It is commonly understood that the laser is the light emitted by the atoms due to the excitation, and the electrons in the atoms absorb energy and then transit from the low energy level to the high energy level, and then fall back from the high energy level to the low energy level, and the released energy is released in the form of photons. The shape of the laser can be divided into continuous laser and pulse laser. The laser is divided into hot laser and cold laser according to the pulse width characteristic of the laser.

A laser emitter such as: but not limited to nanosecond, femtosecond or picosecond laser, the generated laser such as: infrared, infrared, blue light, green light, purple light or polar purple light.

The ultra-fast laser is the pulse laser whose pulse width of the output laser is less than ten nanoseconds, that is, picosecond level or less than picosecond level. The ultra-fast laser involves a core component including an oscillator, a stretcher, an amplifier and a compressor.

In machining, the material or workpiece is generally a material or semi-finished product for the manufacture of parts or parts, and is an object of machining during machining. That is, after machining the work piece, the product meeting the machining or design requirement is obtained.

Precision processing, the processing precision and the surface quality reach the high degree processing technology. For example: in the cutter processing, the size, straightness, profile, surface roughness, blade tip circular arc radius and processing precision are all higher than the micron level.

In the laser processing, the laser removes the material by means of ablation, that is, after the material of the initial surface layer is removed, a new interface is again presented as the surface of the material to be exposed, the laser continues to ablate the material on the new interface again, so as to reciprocate, so as to realize the removal of more material, The processing of the shape of the material is achieved (for example: cutting). Therefore, in the laser processing, the laser always acts on the surface of the material and ablates the material on the surface (surface layer).

A machining apparatus (or machining centre) is a machining apparatus having a plurality of moving shafts. That is, in the right-hand rectangular coordinate system, the X, Y and Z axes moving along the straight line direction, and the A, B and C axes rotating around the X, Y and Z axes, respectively.

A method for laser processing, comprising
a first wedge prism and a second wedge prism are arranged on the laser propagation path, and the laser is firstly incident on the first wedge prism and then incident on the second wedge prism;
the laser emitted from the second wedge prism is focused by the focusing wedge prism to act on the material;
the incident angle of the laser incident first wedge prism is greater than 0 degree and less than or equal to 90 degrees;
the incident angle of the laser incident second wedge prism is greater than 0 degree and less than 90 degrees;
the second wedge prism is deviated from the first wedge prism in position so as to form a laser processed pattern on the material.

The distance between the second wedge prism and the first wedge prism is changed by moving the second wedge prism along a linear path. The first wedge prism is close to or far away from the first wedge prism.

The second wedge prism rotates around the rotary shaft to change the deflection angle relative to the first wedge prism.

In order to deflect the ablation path of the laser on the material, the first wedge prism is further rotated around the rotary shaft. The rotating shaft for the rotation of the first wedge prism and the rotating shaft for the rotation of the second wedge prism are parallel or coaxial.

In order to realize a plurality of patterns, for example: the first wedge prism rotates around the rotary shaft and the second wedge prism rotates around the rotary shaft and moves along the linear path parallel to the axial direction of the rotary shaft.

The second wedge prism moves along a linear path parallel to the axial direction of the rotary shaft, so that the second wedge prism is far away from or close to the first wedge prism, thereby forming a linear pattern on the material, such as: groove or slot.

Another embodiment of the present invention, the second wedge prism is offset in position relative to the first wedge prism, the first wedge prism is rotated about the axis of rotation, and the second wedge prism is also rotated about the axis of rotation, thereby forming a curved pattern on the material, such as an arc or an annular shape.

Another embodiment of the present invention, the first wedge prism is rotated around the rotation axis, and the second wedge prism is rotated around the rotation axis and moved along a linear path parallel to the axial direction of the rotation axis, so as to form a filling pattern on the material. fan surface, round surface or annular surface with radial width.

In order to facilitate the implementation of the method of the present invention, the first wedge prism is a wedge-shaped wedge prism, and the incident angle of the first wedge prism is greater than 0 degree and less than 90 degrees.

In order to implement the method of the invention, the second wedge prism is a wedge-shaped wedge prism.

In order to implement the method of the invention, the first wedge prism and the second wedge prism are the same wedge-shaped wedge prism.

In order to implement the method of the invention, the first wedge prism is a flat wedge prism.

In order to implement the method of the invention, the second wedge prism is a flat wedge prism.

The method provided by the invention controls the movement of the focusing laser point in the circular arc and curve type track based on the polar coordinate mode, for replacing the galvanometer to realize the small-sized straight line, circular arc or curve type pattern (R is less than or equal to 0.5 mm, especially R is less than or equal to 0.05 mm, such as: 0.03 mm to 0.05 mm).

The method provided by the invention can effectively avoid interpolating small straight line section polygon fitting, and can form high-precision circular arc and curve track. For processing the pattern to be filled, for example: The sector, round surface or ring surface with radial width avoids the situation of polygon missing.

Compared with the galvanometer device, the method of the invention is easier to be integrated in the multi-shaft numerical control machine tool system, that is to say, it is controlled as the moving shaft of the numerical control system.

In order to implement the laser processing method of the invention, especially in the integrated and numerical control machine tool, the invention further Claims a device for implementing laser processing,
a rotary motor, comprising a channel, wherein the laser is incident from one end of the channel and then emitted from the other end;
a first wedge prism, which is set on the light path of the laser transmission, driven by the rotary motor to rotate, comprising a first incident surface, so that the incident angle of the laser incident on the first wedge prism is greater than 0 degree and less than 90 degrees;
a distance motor driven by the rotary motor to rotate around a straight line parallel to the axial direction of the optical axis;
a second wedge prism, which is set on the light path of the laser propagation, and is driven by the rotary motor to rotate, and is driven by the distance motor to move along the linear path parallel to the rotary shaft, comprising a second incident surface, the incident angle of the laser incident on the second wedge prism is more than 0 degree and less than 90 degrees;
a focusing lens, which is set on the light path of the laser transmission;
the laser is firstly incident on the first wedge prism and then is emitted after passing through the second wedge prism, and is focused by the focusing wedge prism before acting on the material.

In order to improve the integration of the device of the invention, the distance motor is also installed on the rotary motor and is driven by the rotary motor.

The device of the invention further comprises a beam expanding lens arranged on the laser light path in front of the incident first lens.

The device of the invention, the first wedge prism is wedge-shaped wedge prism laser incident angle of the first wedge prism is more than 0 degrees and less than 90 degrees.

The device of the invention, the second wedge prism is a wedge-shaped wedge prism.

The device of the invention, the first wedge prism and the second wedge prism are the same wedge-shaped wedge prism.

The device of the invention, the first wedge prism is a flat wedge prism.

The device of the invention, the second wedge prism is a flat wedge prism.

The device of the present invention can also carry other optical components, such as: The third wedge prism further adjusts the direction and angle deviation of the laser beam and the central axis of the rotary motor.

The beneficial effects of the technical solution of the invention are as follows:

The invention sets a group of optical wedge prisms on the rotary motor, so that it rotates around the rotary centre to make the focused laser draw the circular arc on the material, which can realize the accurate movement of the circular arc track with the diameter less than 0.05 mm.

By using a distance motor to change the distance between the two optical wedge prisms, the distance between the focused laser point and the laser optical axis can be adjusted.

By controlling the linkage between the distance motor and the rotation motor, the focused light spot can change its distance from the rotation center while rotating around it, thus obtaining any curve trajectory that rotates around the rotation center. This enables the filling of the outlined shape, such as filling the ring into a circular surface with radial width or completely filling it into a circular surface.

### BRIEF DESCRIPTION OF THE DRAWINGS

FIG. 1 is a schematic diagram of an embodiment of a device for implementing the method of laser processing of the present invention;

FIG. 2 is a schematic diagram of an embodiment of the laser processing of materials using the method of the present invention;

FIG. 3 is a schematic diagram of another embodiment of the laser processing of materials using the method of the present invention;

FIG. 4 is a schematic diagram of an embodiment of the laser processing of materials using the method of the present invention;

FIG. 5 is a schematic diagram of another embodiment of the laser processing of materials using the method of the present invention;

FIG. 6 is a schematic diagram of another embodiment of the laser processing materials using the method of the present invention;

FIG. 7 is a schematic diagram of another embodiment of the laser processing materials using the method of the present invention;

FIG. 8 is a schematic diagram of another embodiment of the laser processing materials using the method of the present invention;

FIG. 9 is a schematic diagram of another embodiment of the laser processing of materials using the method of the present invention;

FIG. 10 is a schematic diagram of another embodiment of the laser processing of materials using the method of the present invention;

FIG. 11 is a schematic diagram of another embodiment of the laser processing of materials using the method of the present invention; and

FIG. 12 is a schematic diagram of another embodiment of the laser processing of materials using the method of the present invention.

### DETAILED DESCRIPTION

The technical solution of the present invention is described in detail with reference to the accompanying drawings. Embodiments of the present invention are intended only to illustrate and not to limit the technical solution of the present invention. Although the present invention is described in detail with reference to preferred embodiments, those of ordinary skill in the art should understand that modifications or equivalent substitutions may be made to the technical solution of the present invention without departing from the spirit and scope of the technical solution of the present invention, and should all be covered within the scope of the claims of the present invention.

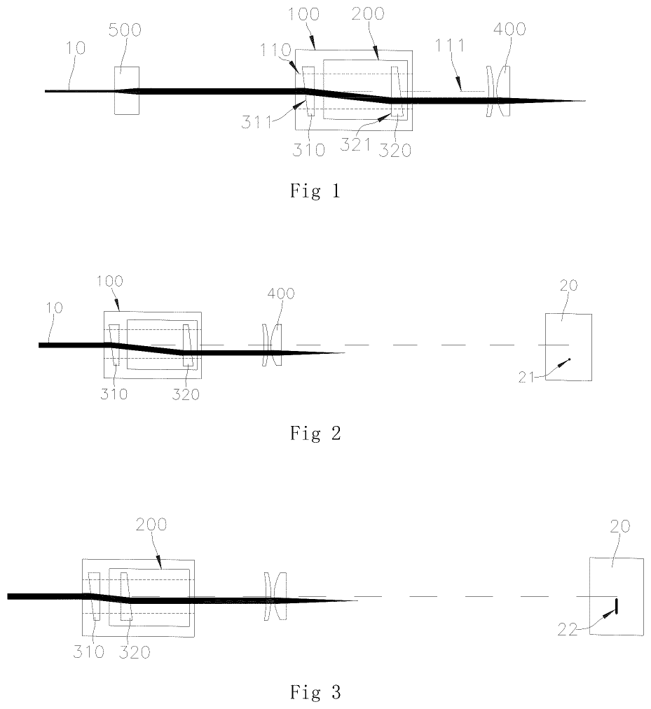

FIG. 1 is a schematic diagram of an embodiment of a device for implementing the method of laser processing of the present invention. As shown in FIG. 1, the apparatus for implementing the laser processing method of the present embodiment comprises a rotary motor 100 and a distance motor 200. The rotary motor 100 includes a channel 110, and the laser light 10 is incident from one end of the channel 100 and then emitted from the other end. In this embodiment, the type of the rotary motor 100 is DR25/M (direct-drive rotary motor), and the type of the distance motor 200 is ZLIN-3 (high-speed voice coil motor).

The first wedge prism 310 is disposed on the optical path where the laser light 10 propagates, and rotates under the driving of the rotary motor 100. The first wedge prism 310 includes a first incident surface 311 so that the incident angle of the laser light 10 incident on the first wedge prism 310 is greater than 0 degree and less than 90 degrees. In this embodiment, the first wedge prism 310 is a wedge-shaped wedge prism.

The second wedge prism 320 is set on the light path where the laser 10 propagates, is driven by the rotating motor 100 to rotate, and is also driven by the distance motor 200 to move along the linear path parallel to the rotating shaft 111, comprising a second incident surface 321, The incident angle of the laser light 10 incident on the second wedge prism 320 is greater than 0 degree and less than 90 degrees. In this embodiment, the second wedge prism 320 is a wedge-shaped wedge prism and has the same specification as the first wedge prism 310.

FIG. 2 is a schematic diagram of an embodiment of laser processing of materials using the method of the present invention. As shown in FIG. 2, the laser light 10 is firstly incident on the first wedge prism 310 and then incident on the second wedge prism 320. The laser light emitted from the second wedge prism 320, after being focused by the focusing wedge prism 400, acts on the material and forms a laser ablation point 21 on the material. In this embodiment, the beam expander 500 is disposed on the laser beam path before the incident first wedge prism 310.

The distance motor 200 drives the second wedge prism 320 to move along a linear path with respect to the first wedge prism 310, for example: A laser processed pattern is formed on the material near the first wedge prism 310 or far away from the first wedge prism 310, such as: groove or slot. FIG. 2 is a schematic diagram of another embodiment of laser processing of materials using the method of the present invention. Referring to FIG. 1 and FIG. 2, as shown in FIG. 3, when the distance motor 200 drives the second wedge prism 320 to move along the straight line path close to the first wedge prism 310, the focused laser acts on the position of the material to move, when the second wedge prism 320 moves along the straight line path close to the first wedge prism 310 continuously, then forming a laser processed seam 22 on the material 20.

In order to implement the method or device of the present invention, it is more suitable for a processing device having a plurality of moving shafts, such as: The three-axis machine tool, the four-axis machine tool and the five-axis machine tool are implemented. Such processing equipment can provide at least two directional movements required to drive the material, such as: The motion in the X-axis direction and the motion in the Y-axis direction are provided, and the motion in the Z-axis direction is generally also provided to meet the processing requirements. In order to realize the processing of the three-dimensional form, the movement around the X axis rotation direction (i.e., the A axis direction), and the movement around the Y axis rotation direction (i.e., the B axis direction) can also be easily obtained from these processing devices.

Since there is already a processing apparatus carrying a laser light source and having a plurality of moving axes, for example, CN212144994. These devices have been equipped with a laser, a focusing (field) wedge prism and a driving device, so that the received laser can be focused to obtain a focused laser beam, and the focused laser beam is guided by the driving device or driven by the driving device to repeatedly move along a straight line.

The method or device of the embodiment is integrated in the machine processing device for controlling, not only controlling the linkage of the distance motor and the rotating motor, making the focusing light spot to rotate around the rotating centre, at the same time, changing the distance between the focusing light spot and the rotating centre, namely obtaining any curve track rotating around the rotating centre, The invention can realize the fan-shaped, arc-shaped and circular processing patterns taking the rotary centre as the divergence point, and the processing patterns filled in the fan-shaped surface and the circular surface. it also can obtain extra rotary shaft, so as to realize the processing pattern drawn and filled around the rotary centre. For example: filling the drawn circle, controlling the linkage of the distance motor and the rotary motor, making the rotary motor rotate through the distance motor in the unit time of a movement increment to control the focusing light spot to finish the linear track movement from the rotary centre to the rotary radius. The wedge-shaped wedge prism group is driven by the rotating motor to rotate for an angle so as to make the laser move for a section of track around the rotating centre, the section of track is the real arc track with the rotating distance as the radius and the rotating arc length as the distance.

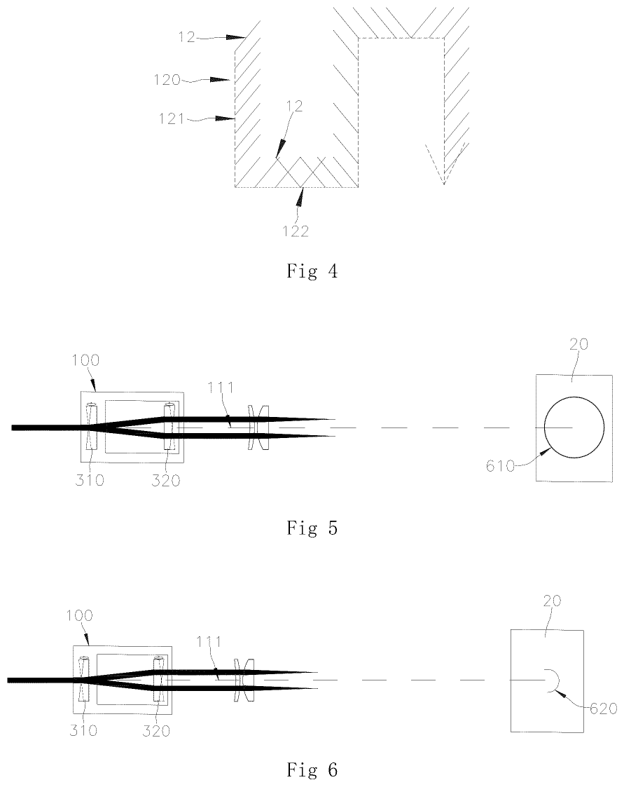

FIG. 4 is a schematic diagram of an embodiment of laser processing of materials using the method of the present invention. Referring to FIG. 1, FIG. 2 and FIG. 3, as shown in FIG. 4, the focused laser beam 12 ablates the material (not shown) along the processing track 120, with only one end falling on the processing track 120 where the workpiece moves, and the arrow on the processing track 120 indicates the direction in which the material moves. The included angle between the focused laser beam 12 and the normal of the processing track 120 is kept in the range of 20° to 70°. When one section of track 121 on the processing track 120 turns to the other section of track 122, the rotary motor 100 rotates a deflection angle (e.g., a deflection angle, a deflection angle, a deflection angle, and a deflection angle). After 30)°, the second wedge prism 320 is driven by the distance motor 200 to move along the linear path close to the first wedge prism 310, so as to generate a track 122 on the material, that is, the focused laser beam 12 is rotated around the laser spot on the processing track 122 as the center, and adjusting the moving direction of the laser beam. The deflection angle of the rotation of the rotary motor 100 is kept unchanged, and the material is moved so that the material can be continuously processed by adjusting the moving direction of the laser beam.

When the rotating motor 100 continuously rotates, so that the first wedge prism 310 and the second wedge prism 320 rotate around the rotating shaft, the focused laser light 10 forms an arc processing track on the material. FIG. 5 is a schematic diagram of another embodiment of the laser processing material using the method of the present invention. Referring to FIG. 1, as shown in FIG. 5, the rotary motor 100 continuously rotates to drive the first wedge prism 310 and the second wedge prism 320 to rotate around the rotary shaft 111, so that the laser light emitted from the second wedge prism 320 is circumferentially distributed, and then focused to form a circular 610 with the material. When the rotary motor 100 continuously rotates less than 360 degrees, a curve or circular arc line is formed on the material. FIG. 6 is a schematic diagram of another embodiment of laser processing materials using the method of the present invention. As shown in FIG. 6, a machining pattern of a major arc shape 620 is formed on the material, and R is less than or equal to 0.05 mm.

The second wedge prism 320 is driven by the distance motor 200 to move along a linear path adjacent to the first wedge prism 310 when further processing of the material in the circular processing pattern is required, i.e., laser ablation of the material in the circular processing pattern. FIG. 7 is a schematic diagram of another embodiment of laser processing materials using the method of the present invention. Referring to FIG. 1 and FIG. 5, as shown in FIG. 7, the distance motor 200 drives the second wedge prism 320 to continuously move along the linear path and approach the first wedge prism 310, and the laser focused by the focusing wedge prism ablates all the material in the circular processing pattern to form a complete circular 630 processing pattern. Based on this similar manner, the distance motor 200 drives the second wedge prism 320 to continuously move along the linear path and away from the first wedge prism 310, after the laser focused by the focusing wedge prism orderly ablates the material located outside the circular processed pattern along the radial direction, A circular ring 640 processing pattern with radial width is formed, R is less than or equal to 0.05 mm, as shown in FIG. 12.

The fan-shaped processing pattern can be obtained by combining said methods. The distance motor 200 drives the second wedge prism 320 to move continuously along a linear path close to the first wedge prism 310, so that a laser-processed slit is formed on the material 20, that is, an edge forming the fan-shaped processed pattern is generated. Then, the rotary motor 100 rotates a deflection angle (such as: After) 30°, the second wedge prism 320 is driven by the distance motor 200 to move along a linear path close to the first wedge prism 310, and then a laser processed slit is formed on the material 20, that is, the other side forming the fan-shaped processed pattern is generated, and a 30° angle processed pattern is obtained. the rotary motor 100 is reset (namely eliminating 30 degrees deflection angle), at the same time of rotating 30 degrees again, the distance motor 200 drives the second wedge prism 320 to move along the straight line path close to the first wedge prism 310, then a laser processed arc-shaped seam is formed on the material 20, The fan-shaped processing pattern is finally drawn out. The distance between the second wedge prism 320 and the first wedge prism 310 is further adjusted every time along the linear path, and after repeated a plurality of times, the material in the delineated fan-shaped processed pattern is completely ablated to form a fan-shaped processed pattern. FIG. 11 is a schematic diagram of another embodiment of laser processing of materials using the method of the present invention. As shown in FIG. 11, a plurality of sector processing patterns 650 are partially overlapped to form a circular processing pattern with which R is less than or equal to 0.05 mm 0.05 mm.

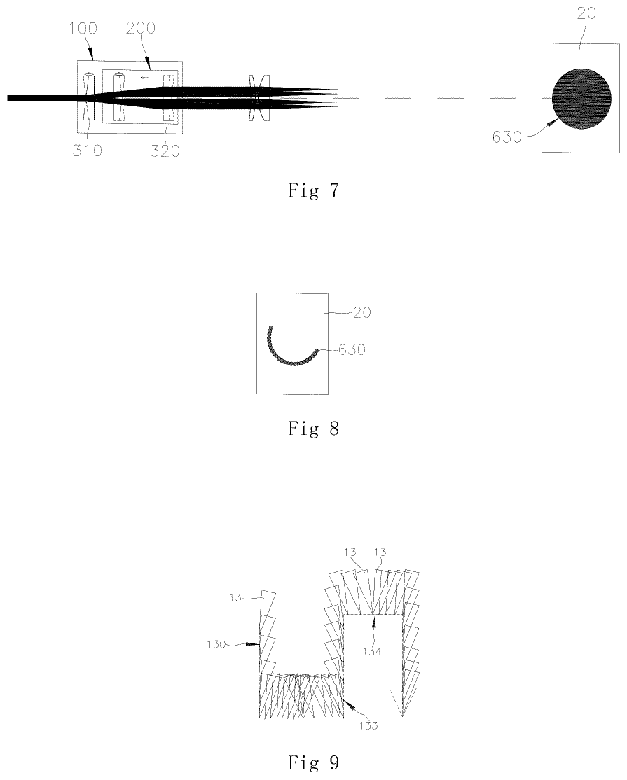

FIG. 8 is a schematic diagram of another embodiment of laser processing materials using the method of the present invention. As shown in FIG. 8, along with the movement of the material, a plurality of circular surface 630 processing patterns are formed on the material, the circular surface 630 processing patterns are overlapped or partially overlapped with each other, so as to realize the effect similar to the laser processing of the material by using the vibration wedge prism, Therefore, it can realize the laser processing without using the vibration wedge prism device, which not only reduces the acceleration and deceleration requirement of the motor, but also improves the precision of the laser processing to the material in the pattern way.

FIG. 9 is a schematic diagram of another embodiment of laser processing of materials using the method of the present invention. As shown in FIG. 9, using the method of this embodiment, a fan-shaped machining pattern 13 is first completed by laser, and this fan-shaped machining pattern is ablated along the machining trajectory 130 on the material (not shown). The arrow on the machining trajectory 130 indicates the direction of workpiece movement. The angle between the normal direction of the fan-shaped machining pattern 13 and the machining trajectory 130 is always maintained within the range of 20° ˜70°. The endpoint of one corner of the fan-shaped processing pattern 13 falls on the processing trajectory 130 of the material movement. When a section of trajectory 133 on processing trajectory 130 turns to another section of trajectory 134, rotate the rotary motor 100 by an angle (i.e., 30)°, causing the newly formed fan-shaped processing pattern 13 to rotate around the laser spot on processing track 134, and adjust the direction of motion of the fan-shaped processing pattern 13 formed by the laser beam.

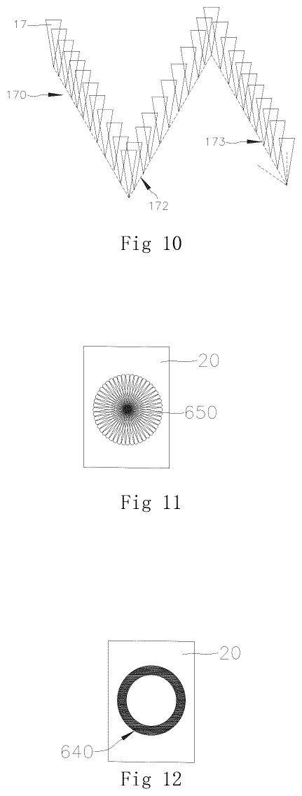

FIG. 10 is a schematic diagram of another embodiment of laser processing of materials using the method of the present invention. As shown in FIG. 10, using the method of this embodiment, a fan-shaped machining pattern 17 is first completed by laser, and the material (not shown) is ablated along the machining trajectory 170 with the fan-shaped machining pattern 17. The arrow on the machining trajectory 170 indicates the direction of workpiece movement. The endpoint of one corner of the fan-shaped machining pattern 17 falls on the machining trajectory 170 of the material movement. The angle between the normal direction of the fan-shaped machining pattern 17 and the machining trajectory 170 is always maintained within the range of 20° ˜70°. Although there is a change in the machining trajectory when one section of trajectory 172 on machining trajectory 170 turns to another section of track 173, the fan-shaped machining pattern 17 can still be machined without changing the direction of motion.

1. A method for laser cutting material, wherein it comprises:
a first wedge prism and a second wedge prism are arranged on the laser propagation path, and the laser is firstly incident on the first wedge prism and then incident on the second wedge prism;
the laser emitted from the second lens acts on the material after being focused by the focusing lens; the incident angle of the laser incident on the first wedge prism is greater than 0 degree and less than or equal to 90 degrees;
the incident angle of the laser incident on the second wedge prism is greater than 0 degree and less than 90 degrees; the second wedge prism is deviated from the first wedge prism so as to form a laser processed pattern on the material.

2. The method according to claim 1, wherein the second wedge prism along the straight line path so as to change the distance with the first wedge prism.

3. The method according to claim 1, wherein the second wedge prism rotates around the rotating shaft to change the deflection angle relative to the first wedge prism.

4. The method according to claim 1, wherein the first wedge prism is rotated around the rotating shaft thereof, the second wedge prism is rotated around the rotating shaft thereof, the rotating shaft for rotating the first wedge prism and the rotating shaft for rotating the second wedge prism are parallel or coaxial.

5. The method according to claim 4, wherein the second wedge prism further moves along the linear path parallel to the axial direction of the rotary shaft.

6. The method according to claim 1, wherein the first wedge prism is a wedge-shaped wedge prism; the incident angle of the laser incident on the first wedge prism is more than 0 degree and less than 90 degrees.

7. The method according to claim 1, wherein the second wedge prism is a wedge-shaped wedge prism.

8. The method according to claim 1, wherein the first wedge prism is a flat wedge prism

9. The method according to claim 1, wherein the second wedge prism is a flat wedge prism.

10. The method according to claim 1, wherein the method is used for controlling the focus laser point to move in the circular arc and curve track based on the polar coordinate mode to form the processing pattern.

11. The method according to claim 1, wherein it is used for the processing device with a plurality of moving shafts.

12. The method according to claim 11, wherein the processing device is a laser processing device.

13. A device for laser processing, wherein it comprises: a rotary motor, comprising
a channel, wherein the laser is incident from one end of the channel and then emitted from the other end;
a first wedge prism, which is set on the light path of the laser transmission and is driven by the rotary motor to rotate, comprising a first incident surface, so that the incident angle of the laser incident on the first wedge prism is greater than 0 degree and less than or equal to 90 degrees;
a distance motor driven by the rotary motor to rotate around a straight line parallel to the axial direction of the optical axis;
a second wedge prism, which is set on the light path of the laser propagation, and is driven by the rotary motor to rotate, and is driven by the distance motor to move along the linear path parallel to the rotary shaft, comprising a second incident surface, the incident angle of the laser incident on the second wedge prism is more than 0 degree and less than 90 degrees;
a focusing lens, which is set on the light path of the laser transmission;
the laser is firstly incident on the first wedge prism and then is emitted after passing through the second wedge prism, and is focused by the focusing wedge prism before acting on the material.

14. The method according to claim 13, wherein the first wedge prism is a wedge-shaped wedge prism.

15. The method according to claim 13, wherein the second wedge prism is a wedge-shaped wedge prism.

16. The method according to claim 13, wherein the first wedge prism is a flat wedge prism.

17. The method according to claim 13, wherein the second wedge prism is a flat wedge prism.

18. The device according to claim 13, wherein the distance motor is also installed on the rotary motor.

19. The device according to claim 13, further comprising a beam expander arranged on the laser light path before the first wedge prism.

20. The device according to claim 13, further comprising a third wedge prism to adjust the direction and angle deviation between the laser and the central axis of the rotary motor.

21. The device according to claim 13, wherein it is set on the machine processing device.
